(19) United States
(12) Patent Application Publication
(10) Pub. No.: US 2013/0011632 A1
(43) Pub. Date: Jan. 10, 2013

(54) MICROFINE STRUCTURE, METHOD FOR PRODUCING MICROFINE STRUCTURE, AND POLYMERIZABLE RESIN COMPOSITION FOR PRODUCING THE SAME

(76) Inventors: Masahiko Ogino, Hitachi (JP); Susumu Komoriya, Tokorozawa (JP); Akihiro Miyauchi, Hitachi (JP); Ryuta Washiya, Hitachi (JP); Kyoichi Mori, Oiso (JP); Noritake Shizawa, Ninomiya (JP)

(21) Appl. No.: 13/519,589

(22) PCT Filed: Dec. 22, 2010
(86) PCT No.: PCT/JP2010/073134

§ 371 Date: Sep. 26, 2012

(30) Foreign Application Priority Data
Dec. 28, 2009 (JP) 2009-296620

(51) Int. Cl. B05D 1/36; B44C 1/22; B32B 3/10

(52) U.S. Cl. 428/195.1; 427/264; 427/510; 216/49

(57) ABSTRACT

Provided is a method for producing a microfine structure comprising the steps of: forming a resin film by applying a liquid polymerizable resin composition containing a high molecular weight component, a low molecular weight component and a reactive dilution component to an adhesion promoting layer formed on a substrate; imprinting a mold with an extremely fine convex concave pattern onto the resin film; and transferring the convex concave pattern to the resin film. Herein, components of the adhesion promoting layer, the high molecular weight component, the low molecular weight component and the reactive dilution component respectively have cross-linking reactive functional groups which react with each other.

### FIELD OF THE INVENTION

The present invention relates to a microfine structure which is transferred from an extremely fine convex concave pattern, a method for producing the microfine structure, and a polymerizable resin composition for producing the microfine structure.

### BACKGROUND OF THE INVENTION

Recently, an integrated semiconductor circuit has been made extremely finer and more integrated. A highly accurate photolithography apparatus has been developed to achieve the pattern transfer technique with the extremely fine fabrication. However, the formation of the circuit with a high accuracy is approaching a limit, as a scale of the micro-fabrication has nearly reached a wavelength of an exposing source for use in the micro-fabrication. To obtain an even higher accuracy, an electron beam printing apparatus, which is a charged particle beam apparatus, has also been used instead of a photolithography apparatus.

However, formation of patterns with the electron beam printing apparatus utilizes a method for printing a mask pattern, which is different from a one-shot exposure method in the pattern formation using light source such as iray and an excimer laser. Therefore, the more patterns are drawn with the electron beam printing apparatus, the more time it takes for exposure (or printing). Hence, the more the circuit of the memory capacity becomes dramatically integrated, for example, from 256 megabytes, 1 gigabyte, up to 4 gigabytes, the more the patterns fall in high densification. This makes the pattern formation time dramatically longer, leading to a concern that a throughput of the pattern formation may be remarkably decreased.

Hereby, to speed up the pattern formation using an electron beam printing apparatus, an electron beam cell projection lithography technique has been developed, in which electron beams are irradiated en bloc on a plurality of combined masks in various shapes. Accordingly, extremely finer sized patterning has been developed focusing on improvement of the apparatus, while such an electron beam printing apparatus becomes inevitably large-sized and more complicated, resulting in requirement of higher costs for producing the apparatus.

In contrast, a transfer technique capable of forming extremely fine patterns at low costs is known (for example, see Patent Documents 1 and 2, and Non-Patent Document 1). In this technique, a mold (or die) with a convex concave pattern corresponding to an extremely fine pattern to be formed on a substrate imprints a hardenable resin disposed on the substrate so as to transfer the convex concave pattern. According to nanoimprint techniques described in Patent Document 2 and Non-Patent Document 1, particularly a silicon wafer is used as a mold, and a microfine structure whose pitch of the convex concave pattern is 25 nm or less may be formed by a transferring step.

Further, after the extremely fine convex concave pattern is transferred on the resin disposed on the substrate, a method for producing a microfine structure which is formed by etching the substrate to form microstructures corresponding to the convex concave pattern through a resin film on which the convex concave pattern was transferred (for example, see Patent Document 3). The method for producing the microfine structure comprises the steps of: using parts of the resin film which form protrusion parts served as masks; and etching the parts of the resin film (or base layer) which form recess parts of the convex concave pattern, and parts of the substrate contacting the base layer, thereby to form a microfine structure on the substrate.

Further, in such a transfer technique, a method for applying a resin for using transcription onto a substrate is disclosed, in which a resin is applied to be distributed as droplets on the substrate by a dispenser (for example, see Patent Document 4). The resin distributed as droplets is to be spread like a film on the substrate when a mold imprints the resin.

### PRIOR ART DOCUMENTS

### Patent Literatures

Patent Document 1: U.S. Pat. No. 5,259,926
Patent Document 2: U.S. Pat. No. 5,772,905
Patent Document 3: Japanese Unexamined Patent Application Publication No. 2002-539604
Patent Document 4: Japanese Unexamined Patent Application Publication No. 2004-504714

### Non-Patent Literature

Non-Patent Document 1: S. Y. Chou et al., Appl. Phys. Lett., vol. 67, p. 3314 (1995)

### DISCLOSURE OF THE INVENTION

### Problems to be Solved by the Invention

However, when a resin is applied as droplets on a substrate in a conventional applying method (for example, see Patent Document 4) and then spread on the substrate through being imprinted by a mold, a case may happen that a bubble is taken in the resin and an uneven thickness thereof is made because the resin droplets have not been uniformly spread on the surface. Then, the bubble taken in the resin and the uneven thickness of the resin may cause a defect in the microstructures made of the resin.

Further, according to a method for producing a microfine structure treated by etching a substrate using transferred convex concave pattern as a mask (for example, Patent Document 3), when an uneven thickness of a resin layer (or base layer) at a recess part of the transferred convex concave pattern is caused, etching fabrication to the substrate is not performed appropriately, resulting in cause of a defect in the obtained microfine structure. More specifically, for example, assume the convex concave pattern in which a thickness in a vertical direction of a base layer has such unevenness that a difference between a maximum thickness and a minimum thickness is 50 nm. Then, when an etching process is subjected with a depth of 50 nm, the substrate is etched at a place where the base layer is thin, while the substrate may not be etched at a place where the base layer is thick. Accordingly, if the predetermined accuracy of the etching has to be maintained, the uniform thickness of the base layer formed on the substrate is required. In other words, if such a base layer with a uniform thickness needs to be formed, the resin layer formed on the substrate needs to have a thin and uniform thickness in the depth direction on the surface thereof.

However, as a conventional resin for being transferred with a convex concave pattern, a hardenable resin comprised of only a plurality of monomer components has been generally used. When such a resin is thinly applied to a substrate, it is demonstrated that the applied resin becomes shrunken thereby to become no film shape.

Therefore, a technique for producing a microfine structure has been demanded, capable of forming a greatly thin and uniform resin film for being transferred with an extremely fine convex concave pattern formed on the substrate, and of reducing the defect occurrence.

### Means for Solving the Problems

Accordingly, an object of the present invention is to provide a microfine structure, a method for producing the microfine structure, and a polymerizable resin composition for producing the microfine structure. Herein, the method is capable of forming a greatly thin and uniform resin film on a substrate so as to transfer an extremely fine convex concave pattern, and of reducing the defect occurrence.

A method of the present invention for solving the aforementioned drawbacks comprises the steps of: forming an adhesion promoting layer on a substrate; forming a resin film by applying a liquid polymerizable resin composition on the adhesion promoting layer, the polymerizable resin composition containing a high molecular weight component, a low molecular weight component and a reactive dilution component; imprinting a mold with an extremely fine convex concave pattern on a one side surface of the resin film thereby to transfer the convex concave pattern thereon; hardening the resin film by polymerizing the polymerizable resin composition while keeping on imprinting the mold onto the resin film; and releasing the mold from the hardened resin film, to form microstructures corresponding to the convex concave pattern. Herein, components of the adhesion promoting layer, the high molecule weight component, the low molecule weight component and the reactive dilution component respectively have cross-linking reactive functional groups each other.

Further, a method of the present invention for solving the aforementioned drawbacks comprises the steps of: forming an adhesion promoting layer on a substrate; forming a resin film by applying a liquid polymerizable resin composition onto the adhesion promoting layer, the polymerizable resin composition containing a high molecular weight component, a low molecular weight component and a reactive dilution component; imprinting a mold with an extremely fine convex concave pattern on a one side surface of the resin film thereby to transfer the convex concave pattern thereon; hardening the resin film by polymerizing the polymerizable resin composition while keeping on imprinting the mold onto the resin film; releasing the mold from the hardened resin film; and etching the substrate using the hardened resin film with the transferred convex concave pattern as a mask. Herein, components of the adhesion promoting layer, the high molecule weight component, the low molecule weight component and the reactive dilution component respectively have cross-linking reactive functional groups each other.

Further, the present invention for solving the aforementioned drawbacks includes a microfine structure on a substrate, the microfine structure comprising a resin film formed by transferring a convex concave pattern through imprinting a mold with the extremely fine convex concave pattern on the resin film via an adhesion promoting layer, and then being hardened. The resin film is formed by applying a polymerizable resin composition onto the substrate. Herein, components of the adhesion promoting layer, the high molecule weight component, the low molecule weight component and the reactive dilution component respectively have cross-linking reactive functional groups each other.

Furthermore, the present invention for solving the aforementioned drawbacks includes a polymerizable resin composition for producing a microfine structure on a substrate through an adhesion promoting layer, the microfine structure forming a resin film which is imprinted by a mold with an extremely fine convex concave pattern, whereby the convex concave pattern is transferred on the resin film. Herein, components of the adhesion promoting layer, the high molecule weight component, the low molecule weight component and the reactive dilution component respectively have cross-linking reactive functional groups each other.

### Advantageous Effects of the Invention

As mentioned hereinbefore, the present invention may form the resin film on which an extremely fine pattern is to be transferred greatly thinly and uniformly, and may provide the microfine structure of which defect occurrence is reduced, the method for producing the microfine structure, and the polymerizable resin composition for producing the microfine structure.

### BRIEF DESCRIPTION OF THE DRAWINGS

FIG. 1A is a perspective diagram schematically showing a microfine structure produced in the method of an embodiment.

FIG. 1B is a partially magnified cross sectional diagram of I-I cross section shown in FIG. 1A.

FIGS. 2A to 2D are step diagrams explaining a method for producing the microfine structure of the embodiment shown in FIG. 1A.

FIGS. 3A to 3D are step diagrams explaining a method for producing a microfine structure of another embodiment.

FIGS. 4A to 4E are step diagrams explaining a procedure for preparing a mold used in Example 1.

FIG. 5 is an image photograph when a surface state of the microfine structure produced in Comparative Example 1 is observed by an optical surface analyzer (OSA).

### EMBODIMENT FOR CARRYING OUT THE INVENTION

As mentioned below, an embodiment of the present invention will be explained in detail referring to attached drawings.

<<Construction of Microfine Structure>>

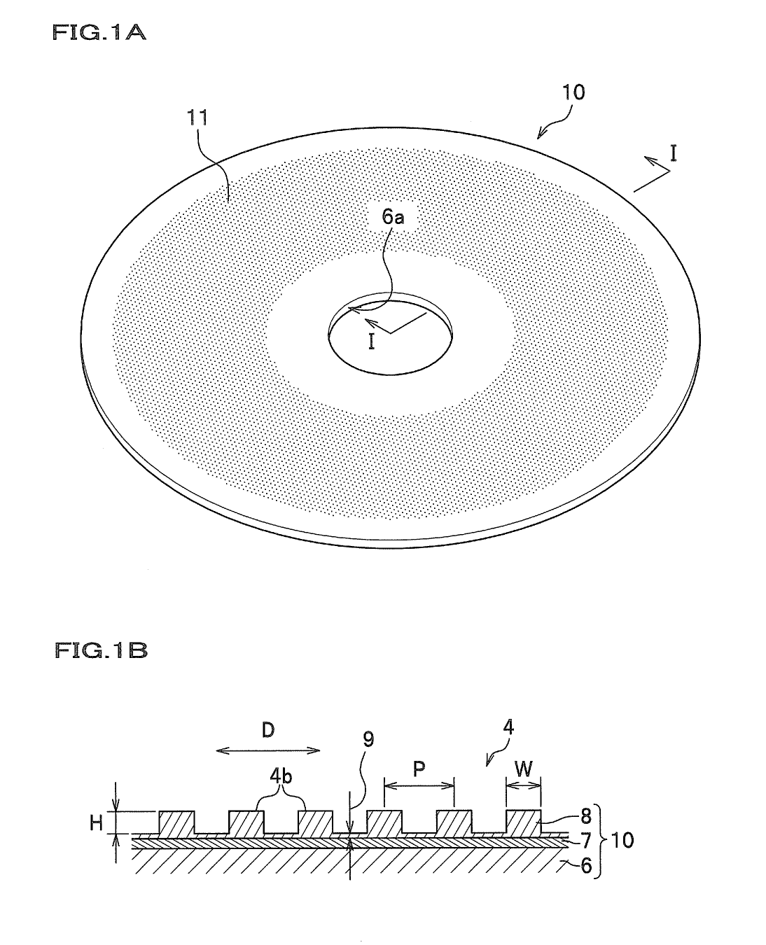

As shown in FIG. 1A, a microfine structure 10 of the present embodiment has a disk shape and a concentric center hole 6a in the center thereof. The microfine structure 10 has microstructures 4 (see FIG. 1B) composed of extremely fine patterns in a ring region 11 on one side face thereof described hereinafter.

Note the microfine structure 10 of the present embodiment may comprise microstructures 4 at both side faces thereof. Further, the region 11 in which the microstructures 4 in the present embodiment are formed is arranged between the outer peripheral part and the inner peripheral part as shown in FIG. 1A. However, the region 11 may be arranged over the whole surface of the microfine structure 10. Alternatively, the region 11 may be formed in other shapes without limiting the ring shape.

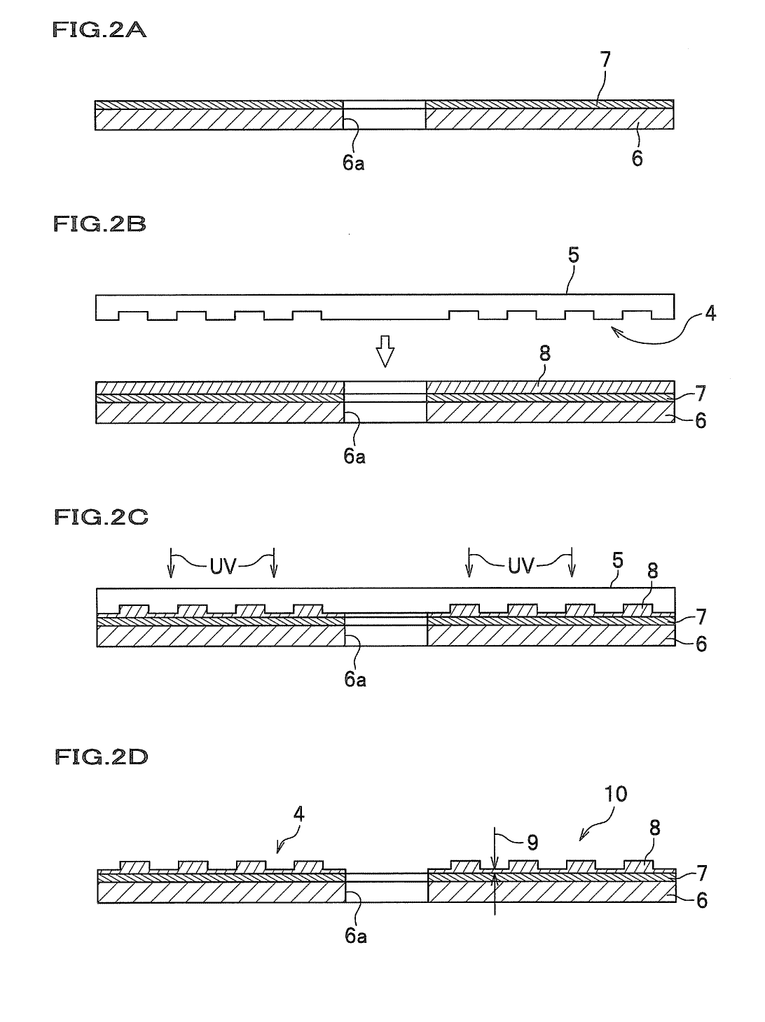

As shown in FIG. 1B, the microstructures 4 of the present embodiment are made of a resin film 8 disposed through an adhesion promoting layer 7 on a substrate 6. A mold 5 with an extremely fine convex concave pattern (see FIG. 2B) described hereinafter imprints the resin film 8, thereby to transfer the convex concave pattern onto the resin film 8 and harden the resin film 8. The resin film 8 is formed by applying a polymerizable resin composition described hereinafter onto the adhesion promoting layer 7 on the substrate 6. Note the adhesion promoting layer 7, the resin film and the polymerizable resin composition will be described in detail hereinafter.

As shown in FIG. 1B, the microstructures 4 are formed such that a plurality of linear protrusions 4b in a substantially square shape stand in a line from a cross sectional view. More specifically, the plurality of linear protrusions 4b are formed such that the plurality of linear protrusions 4b stand in a line as a concentric circle in the diameter direction D of the microfine structure 10. Herein, the linear protrusions 4b in the present embodiment are formed having a width of W, a pitch of P and a height of H, all in a nm (nanometer) size. Further, in FIG. 1B, the resin film 8 at the recess parts of the convex concave pattern forms base layers 9.

Note the microstructures 4 of the present invention are not limited to those linear protrusions 4b. However, depending on the application of the microfine structure 10, for example, other convex concave patterns may be used including pillar protrusions, lamellar protrusions, and pleated protrusions or the like.

The substrate 6 is formed of a plate body having the same plane shape as the microfine structure 10. In the present embodiment, a disk shaped plane having a center hole 6 is used as the substrate 6. The substrate 6 is not a specially limited material as long as the material has a flat surface, appropriate strength and processability. For example, the material includes a silicon wafer, various kinds of metallic materials, glass, silica, ceramic, and plastic or the like. In this connection, the substrate 6 in the present embodiment is assumed as a plate made of a single component. However, the present invention is not limited to the above mentioned material, while a layered material made by stacking a plurality of materials forming layers. Further, the material may be a plate body having a plane shape such as an oval shape and a polygonal shape.

Note the microfine structure 10 using the substrate 6 having a plane shape other than a disk shape, needless to say, the plane shape of the microfine structure 10 should be in the same plane shape as that of the substrate 6.

As the substrate 6 in the present embodiment, the substrate has a disk shape and a concentric center hole 6a in the center of the disk (see FIG. 1A). Preferably, such a substrate may be formed with a more uniform and thinner coating film when a polymerizable resin composition described hereinafter is applied to the substrate by a spin coating method.

<<Method for Producing Microfine Structure>>

Next, a method for producing a microfine structure 10 will be explained mainly referring to FIGS. 2A to 2D. Herein, the convex concave pattern (or microstructures) shown in the drawings are shown schematically.

The production method comprises: an adhesion promoting layer forming step; a resin film forming step, a mold imprinting step, a hardening step and a release step as explained follows.

In the adhesion promoting layer forming step, as shown in FIG. 2A, an adhesion promoting layer is formed on the substrate 6. Herein, the reference 6a in FIG. 2A is a center hole of the substrate (hereinafter, the reference 6a is the same as in FIGS. 2B to 2D).

The adhesion promoting layer 7 is arranged on the substrate 6 so as to increase the adhesiveness between the substrate 6 and the resin film 8. That is, components of the adhesion promoting layer 7 comprise cross-linking reactive functional groups with a high molecular component, a low molecular component and a reactive dilution component, which are the components of the resin film 8 described hereinafter, and also covalent bond forming functional groups with the surface of the substrate 6. Therefore, as long as those functional groups are comprised, the components of the adhesion promoting layer 7 are not particularly limited. Here, among those functional groups, preferably alkoxysilane (or silicon containing compound) including at least one member selected from a group of a (meth)acrylate group, a vinyl group, an epoxy group, and an oxetanyl group. The alkoxysilanes having those functional groups have high reactivity with components of polymerizable resin composition thereby to contribute to improvement of transfer performance achievable within a shorter time.

Those alkoxysilanes include, for example, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, vinyltrichlorosilane, vinyltrimethoxysilane, vinyltriethoxysilane, p-styryltrimethoxysilane, 2-(3,4-epoxycyclohexehyl)ethyltrimethoxysilane, 3-glysidoxypropyltrimethoxysilane, 3-glysidoxypropylmethyldiethoxysilane, 3-glysidoxypropyltriethoxysilane or the like.

In the resin film forming step, as shown in FIG. 2B, a liquid polymerizable resin composition described hereinafter is applied onto the adhesion promoting layer 7, thereby to form a resin film 8.

The resin film 8 in the present embodiment is different from a resin distributed as droplets in a conventional technique for producing a microfine structure (for example, see Patent Document 4). Hereby, the resin film 8 in the present embodiment is a film, more preferably, a continuous film. The terms “film” defined here mean a substantially continuous film of which forming area thereof is 90% or more per the applied area to the substance 6.

A thickness of the resin film 8 in the present embodiment is preferably 100 nm or less.

A method for applying a polymerizable resin composition in the present embodiment is not limited to any specific one as long as the method is capable of applying the polymerizable resin composition to the substrate 6 such that the thickness of the resin film 8 becomes, for example, 100 nm or less. Among the methods, a spin coating method is most preferable.

In the mold imprint step, as shown in FIG. 2B, a mold 5 having microstructures 4 as a die, composed of the extremely fine convex concave pattern (not shown), is imprinted onto the resin film 8, thereby to transfer the convex concave pattern.

The mold 5 is not limited to any specific one as long as the mold 5 has appropriate strength and realizes required fabrication accuracy including, for example, various types of metallic materials, glass, silica, ceramic, and a resin material or the like. More specifically, the mold 5 preferably includes Si, SiC, SiN, SiO₂, polycrystalline Si, Ni, Cr, Cu, a photocurable resin, and at least one member selected from the above mentioned material. Above all, the mold 5 made of silica has high transparency. Such a mold is preferable, allowing light (or ultraviolet light) to be efficiently irradiated through the mold 5 to the polymerizable resin composition, when the polymerizable resin composition is changed to be photohardened. In this connection, when a mold 5 made of a no light transparent material is used, a transparent substrate 6 is used for hardening the polymerizable resin composition by irradiating light from the side of the substrate 6 to the polymerizable resin composition.

Further, when a foreign substance exists on a surface of the substrate 6, a mold 5 made of an elastic resin material, which is imprinted onto the resin film 8, is elastically deformed in the vicinity of the foreign substance or the like. The elastic mold 5 allows a defect region around the foreign substance (or region incapable of transferring) to be finer than a mold 5 with high rigidity. Therefore, the elastic mold 5 is more preferable.

Further, a method for forming a convex concave pattern on the mold 5 is not particularly limited. For example, the method includes, for example, photolithography, focused ion beam lithography, electron beam printing, and nano printing. Those methods may be appropriately selected corresponding to required fabrication accuracy of the convex concave pattern.

On the surface of the mold 5 as mentioned hereinbefore, preferably a mold-releasing treatment is subjected in order to facilitate mold-releasability of the mold 5 from the hardened resin film 8. As a mold-releasing treatment, for example, a mold-releasing agent such as silicone based and fluorine based agents is applied to the surface of the mold 5 with a thickness of several nanometers. Alternatively, a thin film made of a metallic compound may be formed on the surface of the mold 5 as a mold-releasing layer.

In a hardening step, as shown in FIG. 2C, ultraviolet light is irradiated to the resin film 8 with keeping the mold 5 imprinted on the resin film 8, thereby to harden the resin film 8. In the hardening step in the present embodiment, assuming that a light transparent material is used for the mold 5, ultraviolet light is irradiated from the mold 5 side.

In a release step, the mold 5 is released from a hardened resin film 8.

As a result, as shown in FIG. 2D, a microfine structure 10 is obtained, having the resin film 8 on which the microstructures 4 are transferred from the substrate 6, so as to correspond to the microstructures 4 of the mold 5 (see FIG. 2B). Herein, in FIG. 2D, the reference 9 indicates a base layer.

<<Polymerizable Resin Composition>>

Next, a polymerizable resin composition of the present invention, which forms the resin film 8 of the microfine structure 10 (see FIG. 1B) will be explained.

The polymerizable resin composition may be a liquid containing a high molecular weight component, a low molecular weight component, and a reactive dilution component, and form the resin film 8 through a spin coating method. A polymerization type of the polymerizable resin composition may be any of the type selected from a radical polymerization, a cationic polymerization, and an anionic polymerization. Additionally, the polymerizable resin composition in the present embodiment further comprises a photopolymerization initiator to compose a photo hardenable resin composition. In contrast, the polymerizable resin composition of the present invention may be a thermo hardenable resin composition.

The high molecular weight component is not specifically limited as long as the molecular thereof contains cross-linking reactive functional groups which react with components of the adhesion promoting layer 7, the low molecular weight component and a reactive dilution component described hereinafter. However, preferably the high molecular weight component has a number average molecular weight (Mn) of 300 or more, more preferably is an oligomer in which the repeated unit number of composed monomers is 20 or less.

Those high molecular weight components include, for example, a methyl poly(meth)acrylate resin, an ethoxylated bisphenol A type acrylate resin, an aromatic urethane acrylate resin, an aliphatic urethane acrylate resin, a polyester acrylate resin, an unsaturated polyester resin, an acrylic modification alicyclic epoxy resin, a bisphenol A type epoxy resin, a hydrogenated bisphenol A type epoxy resin, a bisphenol F type epoxy resin, a novolac type epoxy resin, an aliphatic cyclic epoxy resin, a naphthalene type epoxy resin, a biphenyl type epoxy resin, and a bifunctional alcohol ether type epoxy resin or the like. Above all, the high molecular weight component has preferably at least one member selected from a (meth)acrylate group, a vinyl group, an epoxy group, and an oxetanyl group.

A low molecular weight component is not particularly limited as long as the molecular thereof contains cross-linking reactive functional groups with components of the adhesion promoting layer 7, the high molecular weight component and the reactive dilution component described hereinafter. However, preferably the low molecular weight component is a monomer. Above all, either of the monomer ends has preferably at least one member selected from a (meth)acrylate group, a vinyl group, an epoxy group, and an oxetanyl group. Particularly, a monomer with a molecular weight of less than 300 is more preferable.

The monomer having a (meth)acrylate group includes, for example, phenoxyglycol (meth)acrylate, phenoxyethylene glycol (meth)acrylate, phenoxypolyethylene glycol (meth)acrylate, methoxytriethylene glycol (meth)acrylate, methoxypolyethylene glycol (meth)acrylate, biphenyl (meth)acrylate, isobornyl (meth)acrylate, octoxypolyethylene glycol (meth)acrylate, 2-hydroxy-3-phenoxypropyl (meth)acrylate, isostearyl (meth)-acrylate, lauryl (meth)acrylate, polyethylene glycol di(meth)acrylate, ethoxylated bisphenol A di(meth)acrylate, propoxylated bisphenol A di(meth)acrylate, 1,10-decanediol di(meth)acrylate, cyclodecanedimethanol di(meth)acrylate, ethoxylated 2-methyl-1,3-propanediol di(meth)acrylate, neopentyl glycol di(meth)acrylate, 2-hydroxy-3-acryloyloxypropyl (meth)acrylate, propoxylated ethoxylated bisphenol A di(meth)acrylate, 1,6-hexanediol di(meth)acrylate, 1,9-nonanediol di(meth)acrylate, dipropylene glycol di(meth)acrylate, tripropylene glycol di(meth)acrylate, polypropylene glycol di(meth)acrylate, ethylene glycol di(meth)acrylate, di-ethylene glycol di(meth)acrylate, triethylene glycol di(meth)acrylate, tetraethylene glycol di(meth)acrylate, ethoxylated isocyanuric acid triacrylate, ethoxylated trimethylolpropane tri(meth)acrylate, trimethylolpropane tri(meth)acrylate, propoxylated trimethylolpropane tri(meth)acrylate, pentaerythritol tri(meth)acrylate, ethoxylated pentaerythritol tetra(meth)acrylate, ditrymethylolpropane tetra(meth)acrylate, propoxylated pentaerythritol tetra(meth)acrylate, pentaerythritol tetra(meth)acrylate, dipentaerythritol hexa(meth)acrylate or the like.

Further, a (meth)acrylate derivative having a cyclic structure in a molecular chain is preferable due to the excellent resistance to dry etching. Above all, particularly, benzyl (meth)acrylate, cyclohexyl (meth)acrylate, cyclopentyl (meth)acrylate, cyclopentenyl (meth)acrylate, and adamantly (meth)acrylate.

A monomer having a vinyl group includes, for example, ethylene glycol divinyl ether, diethylene glycol divinyl ether, triethylene glycol divinyl ether, tetraethylene glycol divinyl ether, butanediol divinyl ether, hexanediol divinyl ether, cyclohexanedimethanol divinyl ether, isophthalic acid di(4-vinyloxy)butyl, glutaric acid di(4-vinyloxy)butyl, succinic acid (4-vinyloxy)butyl trimethylolpropane trivinyl ether, 2-hydroxyethyl vinyl ether, hydroxybutyl vinyl ether, hydroxyhexyl vinyl ether or the like.

A monomer having an epoxy group includes, for example, an alicyclic epoxide with a low molecular weight, a bisphenol A type epoxide, a hydrogenated bisphenol A type epoxide, a bisphenol F type epoxide, a novolac type epoxide, an aliphatic cyclic epoxide, a naphthalene type epoxide, a biphenyl type epoxide, a bifunctional aliphatic alcohol ether type epoxide, 1,6-hexanediol glycidyl ether, 1,4-butanediol glycidyl ether or the like.

A monomer having an oxetanyl group includes, for example, 3-ethyl-3-hydroxymethyloxetane, 1,4-bis[(3-ethyl-3-oxetanylmethoxy)methyl]benzene, 3-ethyl-3-(phenoxymethyl)-oxetane, bis[1-ethyl(3-oxetanyl)]-methyl ether, 3-ethyl-3-(2-ethylhexyloxymethyl)oxetane, 3-ethyl-3-{[3-(triethoxysilyl)propoxy]methyl}oxetane, oxetanylsilsesqui-oxane, phenol novolac oxetane or the like.

The monomer of the present invention has at least one member selected from a (meth)acrylate group, a vinyl group, an epoxy group and an oxetanyl group, in the molecular chain thereof. That monomer may be basically used in the present invention as long as the monomer has low viscosity at room temperature.

A reactive dilution component mainly dilutes the polymerizable resin composition thereby to decrease the viscosity of the polymerizable resin composition. The polymerizable resin composition is not limited to any particular one as long as the composition has cross-linking reactive functional groups with the components of the adhesion promoting layer 7, the high molecular weight component, and the low molecular weight component, while the composition is preferably a monomer. Above all, a monomer having at least one member selected from a (meth)acrylate group, a vinyl group, an epoxy group and an oxetanyl group at either end of the molecule.

Such a reactive dilution component includes, for example, N-vinylpyrrolidone, acryloylmorpholine, N, N-dimethylacrylamide, N-methylolacrylamide, N,N-dimethylaminopropylacrylamide, vinyl (meth)acrylate, allyl (meth)acrylate, methallyl (meth)acrylate, acryl glycidyl ether, alkylphenol monoglycidyl ether, acryl glycidyl ether, 2-ethyl-hexyl glycidyl ether, phenyl glycidyl ether, 2-ethylhexyloxetane or the like. Above all, vinyl (meth)acrylate is preferable due to the excellent film formation.

A photopolymerization initiator is not particularly limited as long as the initiator generates radicals, cations and anions, corresponding to a polymerization type of the polymerizable resin composition. For example, that reaction type includes a radical polymerization type, a cationic polymerization type and an anionic polymerization type, when ultraviolet light is irradiated to the initiator. Herein, selected is a photopolymerization initiator which may promote the cross-linking reaction among the functional group in the components of the adhesion promoting layer 7, the functional group in the component of the polymerizable resin composition, and the functional group in the reactive dilution component each other.

A photopolymerization initiator initiating the cross-linking reaction of a (meth)acrylate group and a vinyl group includes, for example, 2,2-dimethoxy-1,2-diphenylethane-1-one, 1-hydroxycyclohexylphenylketone, 2-hydroxy-2-methyl-1-phenylpropane-1-one, benzophenone, 1-[4-(2-hydroxyethoxy) phenyl]-2-hydroxy-2-methyl-1-propane-1-one, 2-methyl-1-[4-(methylthio)phenyl]-2-morpholinopropane-1-one, 2-benzyl-2-dimethylamine-1-(4-morpholinophenyl)butan-1-one, bis(2,6-dimethoxybenzoyl)-2,4,4-trimethylpentylphosphin oxide, 2-hydroxy-2-methyl-1-phenylpropane-1-one, bis(η⁵-2,4-cyclopentadien-1-yl)-bis[2,6-difluoro-3-(1H-pyrrol-1-yl)-Phenyl]titanium or the like. The above initiators may be used alone, while any combination of at least two inhibitors may also be used.

The photopolymerization initiator initiating the cross-linking reaction of an epoxy group and an oxetanyl group includes, for example, an iron arene complex compound, an aromatic diazonium salt, an aromatic iodonium salt, aromatic sulphonium salt, a pyridinium salt, an aluminum salt/silyl ether, a protonic acid, a Lewis acid or the like. The above initiators may be used alone, while any combination of at least two initiators may also be used.

Further, a commercially available product of a cationic type polymerization initiator which initiates hardening of the polymerizable resin composition by ultraviolet light includes, for example, IRGACURE261 (CIBA-GEIGY LTD.), OPTOMER-SP-150 (ADECA CO.), OPTOMER-SP-151 (ADECA CO.), OPTOMER-SP-152 (ADECA CO.), OPTOMER-SP-170 (ADECA Co.), OPTOMER-SP-171 (ADECA CO.), OPTOMER-SP-172 (ADECA CO.), UVE-1014 (GENERAL ELECTRONIC COMPANY), CD-1012 (SARTOMER COMPANY INC.), SANAIDSI-60L (SANSHIN CHEMISTRY INDUSTRY CO., LTD.), SANAID SI-80L (SANSHIN CHEMISTRY INDUSTRY CO., LTD.), SANAID SI-100L (SANSHIN CHEMISTRY INDUSTRY CO., LTD.), SANAID SI-110 (SANSHIN CHEMISTRY INDUSTRY CO., LTD.), SANAID SI-180 (SANSHIN CHEMISTRY INDUSTRY CO., LTD.), CI-2064 (NIPPON SODA CO., LTD.), CI-2639 (NIPPON SODA CO., LTD.), CI-2624 (NIPPON SODA CO., LTD.), CI-2481 (NIPPON SODA CO., LTD.), UVACURE 1590 (DAICEL-UCB CO., LTD.), UVACURE 1591 (DAICEL-UCB CO., LTD.), RHODORSIL PHOTO IN ITIATOR 2074 (RHONE-POULENC S.A.), UVI-6990 (UNION CARBIDE CORPORATION), BBI-103 (MIDORI KAGAKU CO., LTD.), MPI-103 (MIDORI KAGAKU CO., LTD.), TPS-103 (MIDORI KAGAKU CO., LTD.), MDS-103 (MIDORI KAGAKU CO., LTD.), DTS-103 (MIDORI KAGAKU CO., LTD.), NAT-103 (MIDORI KAGAKU CO., LTD.), NDS-103 (MIDORI KAGAKU CO., LTD.), CYRAURE UVI 6990 (UNION CARBIDE CORPORATION) or the like. Those cationic polymerization initiators may be used alone, while the combination of two initiators or more may be also used.

Blending quantities of the high molecular weight component, the low molecular weight component, and the reactive dilution component in the polymerizable resin composition may be determined as follows: the high molecular weight component of 1 part by weight, the low molecular weight component of 1 to 10 parts by weight, and the reactive dilution component of 10 to 100 parts by weight.

Further, the viscosity of the polymerizable resin composition is preferably set to 10 mPa·s or less.

The above mentioned polymerizable resin composition may be combined with a polymerization promoter, a sensitizer, and a surfactant or the like. Further, a polymerization inhibitor may be added where necessary.

According to the method for producing the microfine structure 10 as mentioned hereinbefore, the resin film 8 may be greatly thinly and uniformly formed on the substrate 6. On the other hand, the conventional method for producing a microfine structure (for example, see Patent Document 4) distributes a hardenable resin as droplets on a substrate. To be specific, since in the production method of the present invention, the polymerizable resin composition contains the reactive dilution components, the resin composition is applied thinly and uniformly onto the substrate 6 by the spin coating method.

Further, in the production method of the present invention, the polymerizable resin composition (or resin layer 8) spreading as a film, which is different from a hardenable resin distributed as droplets described in the conventional production method (for example, see Patent Document 4). This film like composition is imprinted by the mold 5 to transfer the convex concave pattern, allowing bubbles not to be rolled into the resin film 8, thereby to spread the polymerizable resin composition uniformly, causing a uniform thickness.

Further, in the production method of the present invention, the reactive dilution component has cross-linking reactive functional groups which react with the high molecular weight component and the low molecular weight component composing the polymerizable resin composition. Accordingly, the dilution component is not volatized when the polymerizable resin composition is hardened, which is different from a polymerizable resin component used as a dilution component made of a volatile solvent. This prevents the hardened resin film 8 from forming voids which remain as traces of the volatile solution in the resin film 8.

Further, in the production method of the present invention, the components of the polymerizable resin composition (or the high molecular weight component, low molecular weight component and the reactive dilution component) and the components of the adhesion promoting layer 7 have cross-linking reactive functions each other. This allows the bondability between the hardened resin layer 8 and the substrate 6 to become excellent. Accordingly, even though the base layer 9 is formed as extremely thin, the base layer 9 may be prevented from being dropped from the substrate 6 when the mold 5 is released from the hardened resin film 8.

Then, the microfine structure 10 obtained in the production method may be applied to information storage media such as a magnetic storage medium and an optical storage medium. Further, the microfine structure 10 may be also applied to a large-scale integration, optical parts such as a lens, a polarizing plate, a wavelength filter, a light emitting device and optical integrated circuit, an immunoassay, a DNA separation, a bio device for using cell culture or the like.

As mentioned hereinbefore, the present embodiment of the present invention has been explained. However, the present invention is not limited to the aforementioned embodiment and may be utilized in various aspects.

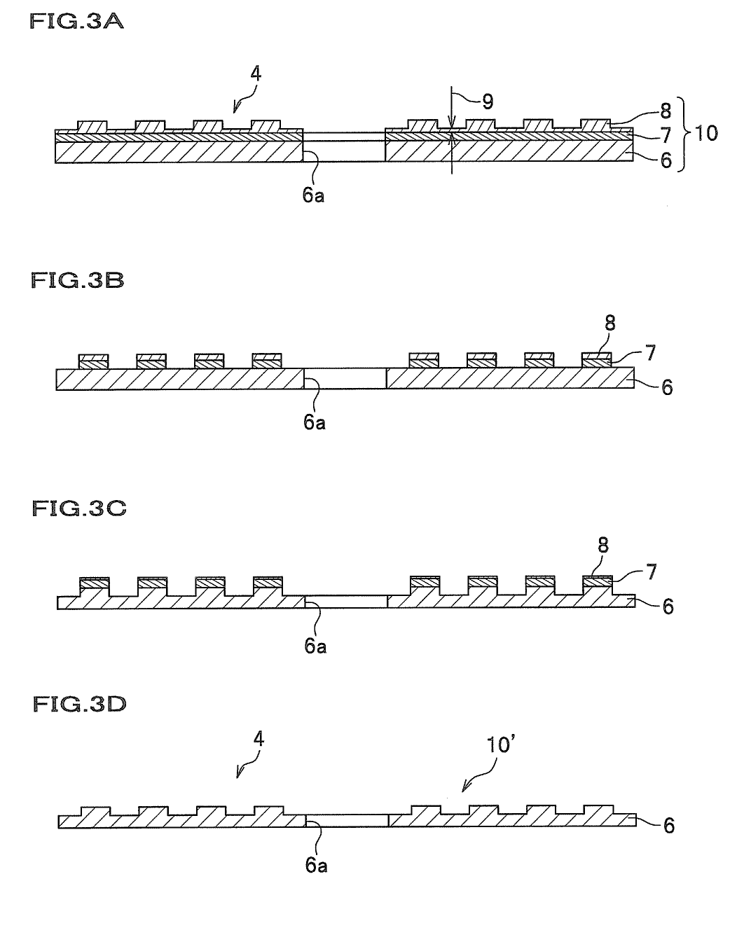

In the embodiment mentioned before, the microfine structure 10 (see FIG. 2D) is produced by transferring the microstructures 4 (see FIG. 2B) composing the convex concave pattern onto the resin film 8 disposed on the substrate 6 through the adhesion promoting layer 7. Alternatively, the present invention may include a method for producing a microfine structure by etching the substrate 6 using the resin film 8 as a mask having a convex concave pattern. In this context, FIGS. 3A to 3D to which are referring are step diagrams explaining a method for producing a microfine structure of a different embodiment. Note in FIGS. 3A to 3D, the same components as in the previous embodiment will be shown by the same reference numerals, and detailed explanation thereof will be omitted.

In the production method, as shown in FIG. 3A, the microfine structure 10 obtained in the production method of the aforementioned embodiment is prepared. In FIG. 3A, the reference 4 represents microstructures composing an extremely fine convex concave pattern, the reference 6 represents a substrate, the reference 7 represents an adhesion promoting layer, the reference 8 represents a resin film to which microstructures 4 of the mold 5 are transferred, the reference 6a represents a center hole of the substrate 6, and the reference 9 represents a base layer.

Then, as shown in FIG. 3B, in the production method, the resin film 8 is etched thereby to expose a surface of the substrate 6. That is, in the etching step, a part of the resin film 8 constructing a protrusion part of the convex concave pattern is used as a mask, and then a part of the resin film 8 (or base layer 9) constructing a recess part of the convex concave pattern is etched.

Next, as shown in FIG. 3C, the part of the resin film 8 remaining on the substrate 6 is used as a mask, and then a surface of the exposed substrate 6 is etched.

Accordingly, a convex concave pattern corresponding to the convex concave pattern of the resin film 8 shown in FIG. 3A is formed on the substrate 6.

Then, the resin film 8 and the adhesion promoting layer 7 remaining on the substrate 6 are removed. This step produces a microfine structure 10′ comprised of the substrate 6 on which surface the convex concave pattern is formed corresponding to the convex concave pattern of the resin film 8 as shown in FIG. 3D.

According to the production method of the microfine structure 10′, a part of the resin film 8 (or base layer 9) forming a recess part of the convex concave pattern is etched thereby to expose a surface of the substrate 6. Then, when the exposed substrate 6 is further etched, as mentioned before, the base layer 9 is extremely thin and has a uniform thickness, allowing the convex concave pattern accurately to be etched uniformly and without a defect on the substrate 6 corresponding to the convex concave pattern of the resin film 8. Accordingly, the microfine structure 10′ has no defects and the uniform convex concave pattern.

### EXAMPLES

Next, referring to following examples, the present invention will be more specifically explained. Note all the terms “part(s)” and “%” used below represent a mass standard unless specially indicated.

### Example 1

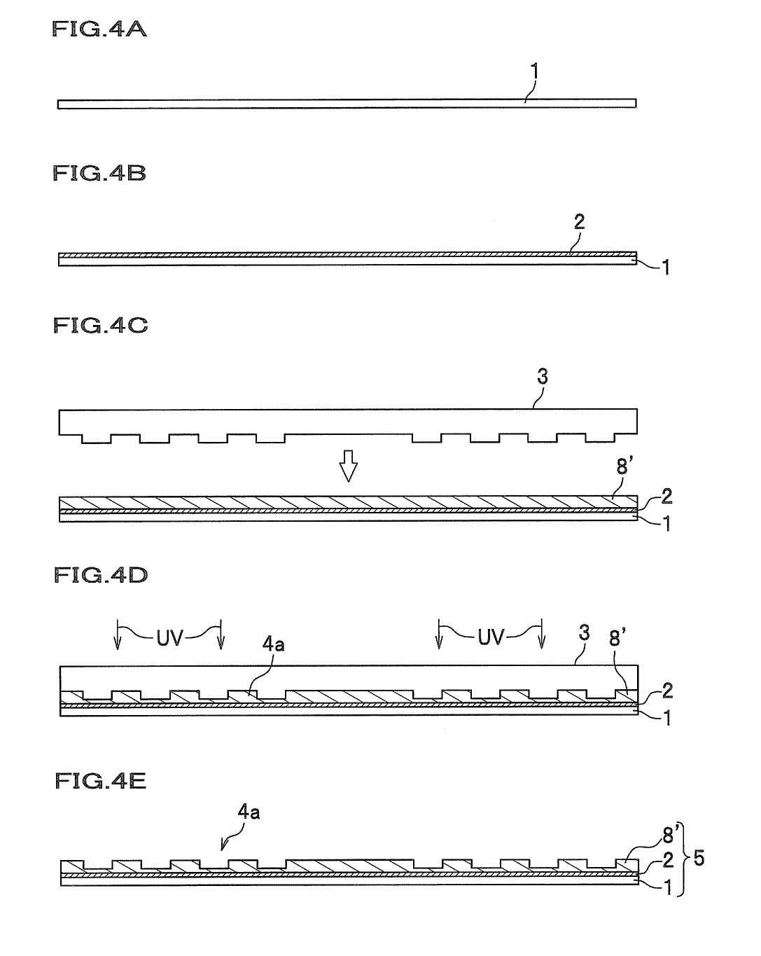

In Example 1, first a mold (or die) was prepared. Here, FIGS 4A to 4E show step diagrams explaining a preparation flow of a mold used in the present example.

In the preparation flow of the mold, as shown in FIG. 4A, first a mold base material 1 was prepared. The mold base material 1 was prepared by applying γ-acryloyloxypropyltrimethoxysilane (KBM5103: SHIN-ETSU CHEMICAL CO., LTD.) to a surface of a silica plate (150 mm×150 mm×0.7 mm), which is a coupling treatment.

Next, as shown in FIG. 4B, an optical adhesive (NOA65: NOLAND PRODCUCTS INC.) was applied to a surface of the mold base material 1 that underwent the coupling treatment by a spin coating method, thereby to photo-harden the adhesive for forming a buffer layer 2 with a thickness of 70 μm. Then, as shown in FIG. 4C, was imprinted a master mold 3 subjected with a mold-releasing treatment beforehand by OPTOOL DSX (DAIKIN INDUSTRIES LTD.) on a radical polymerizable phtohardening acryl resin 8′ which was applied on a surface of the buffer layer 2. Simultaneously, as shown FIG. 4D, ultraviolet light (wavelength=365 nm; irradiation condition=30 J/cm²) was irradiated keeping the imprinting state to harden the phtohardening acryl resin 8′. Accordingly, the convex concave pattern of the master mold 3 was transferred on the mold base material 1 thereby to form a pattern layer 4a.

In the above step, the phtohardening acryl resin 8′ was dropped in the vicinity of the center of the buffer layer 2. The dropped volume thereof was 100 μL. Further, a disk shaped material was used as the master mold 3, made of silica having a convex concave pattern in which linear protrusions were continuously arranged in a concentric circular pattern, at a circular region in the range from an inner diameter of 30 mm φ to an outer diameter of 60 mm φ. The protrusion has a width of 50 nm, a height of 40 nm, and an interval (or pitch) between the protrusions was 90 nm.

Then, in the preparation step, the master mold 3 was released from the pattern layer 4a, thereby to obtain a mold 5 having the pattern layer 4a on the buffer layer 2 on the mold base material 1, as shown FIG. 4E.

Note the mold 5 forming the convex concave pattern on the phtohardening acryl resin 8′ may be called a resin mold 5 hereinafter.

Next, a method for producing the microfine structure 10 in the present example using the mold 5 will be explained referring to FIGS. 2A to 2D.

In the production method, as shown in FIG. 2A, an adhesion promoting layer 7 was formed on a surface of a disk shaped substrate 6 (made of glass; thickness=635 μm) with an outer diameter of 65 mm φ and a center hole 6 having an inner diameter of 20 mm φ. The adhesion promoting layer 7 was formed by vapor depositing γ-acryloyloxypropyltrimethoxysilane ((KBM5103: SHIN-ETSU CHEMICAL CO., LTD.) in a vapor deposition method.

Then, as shown FIG. 2B, a resin film 8 was formed by applying a liquid polymerizable resin composition to the adhesion promoting layer 7. As shown in Table 1, the polymerizable resin composition contains: a styrene type unsaturated polyester resin (SUNDHOMA (registered trademark) CN-325: DHM MATERIAL INC.) as a high molecular weight component in one part by weight; benzyl methacrylate (molecular weight=176, FA-BZM: HITACHI CHEMICAL CO., LTD.) in one part by weight and neopentyl glycol diacrylate (molecular weight=212, SHIN-NAKAMURA CHEMICAL CO., LTD.) in one part by weight as monomer components; vinyl methacrylate (molecular weight=126, TOKYO CHEMICAL INDUSTRY CO., LTD.) as a reactive dilution component in 30 parts by weight; and a photoreaction initiator (I-369: CIBA SPECIALITY CHEMICALS INC.) in 0.3 parts by weight.

TABLE 1

| | | AD- | | | | | | |
|---|---|---|---|---|---|---|---|---|
| | | HESION | | | | | | |
| | | PRO- | HIGH | | | | | PROFILE OF |
| | | MOT- | MOLECULAR | LOW MOLECULAR | | REACTIVE | | APPLIED |
| | SUB- | ING | WEIGHT | WEIGHT COMPONENT | | DILUTION | APPLYING | FILM (FILM |
| | STRATE | LAYER | COMPONENT | (MONOMER) | | COMPONENT | METHOD | THICKNESS) |
| EXAMPLE 1 | GLASS | KBM5103 | UNSAT- | BENZYL | NPG | VINYL | SPIN | FILM |
| | SUB- | | URATED | METHACRYLATE | | METHACRYLATE | COATING | (60 nm ± 5 nm) |
| | STRATE | | POLY- | | | | | |
| | | | ESTER | | | | | |
| | | | RESIN | | | | | |
| EXAMPLE 2 | SILICON | KBM5103 | UNSAT- | BENZYL | NPG | VINYL | SPIN | FILM |
| | WAFER | | URATED | METHACRYLATE | | METHACRYLATE | COATING | (60 nm ± 5 nm) |
| | | | POLY- | | | | | |
| | | | ESTER | | | | | |
| | | | RESIN | | | | | |
| EXAMPLE 3 | GLASS | KBM5103 | EPOXY- | BENZYL | NPG | VINYL | SPIN | FILM |
| | SUB- | | ACRYLATE | METHACRYLATE | | ACRYLATE | COATING | (60 nm ± 5 nm) |
| | STRATE | | RESIN | | | | | |
| EXAMPLE 4 | SILICON | KBM5103 | EPOXY- | BENZYL | NPG | VINYL | SPIN | FILM |
| | WAFER | | ACRYLATE | METHACRYLATE | | ACRYLATE | COATING | (60 nm ± 5 nm) |
| | | | RESIN | | | | | |
| EXAMPLE 5 | GLASS | KBM5103 | EPOXY | PHENYL | EX-212L | ALLYL GLYCIDYL | SPIN | FILM |
| | SUB- | | RESIN | GLYCIDYL | | ETHER | COATING | (60 nm ± 5 nm) |
| | STRATE | | | ETHER | | | | |
| EXAMPLE 6 | SILICON | KBM5103 | EPOXY | PHENYL | EX-212I | ALLYL GLYCIDYL | SPIN | FILM |
| | WAFER | | RESIN | GLYCIDYL | | ETHER | COATING | (60 nm ± 5 nm) |
| | | | | ETHER | | | | |
| COM- | GLASS | KBM5103 | UNSAT- | BENZYL | NPG | VINYL | INK JET | DROPLETS |
| PARATIVE | SUB- | | URATED | METHACRYLATE | | METHACRYLATE | | |
| EXAMPLE 1 | STRATE | | POLY- | | | | | |
| | | | ESTER | | | | | |
| | | | RESIN | | | | | |
| COM- | GLASS | KBM5103 | — | BENZYL | NPG | VINYL | SPIN | — |
| PARATIVE | SUB- | | | METHACRYLATE | | METHACRYLATE | COATING | |
| EXAMPLE 2 | STRATE | | | | | | | |
| COM- | GLASS | — | UNSAT- | BENZYL | NPG | VINYL | SPIN | FILM |
| PARATIVE | SUB- | | URATED | METHACRYLATE | | METHACRYLATE | COATING | (60 nm ± 5 nm) |
| EXAMPLE 3 | STRATE | | POLY- | | | | | |
| | | | ESTER | | | | | |
| | | | RESIN | | | | | |
| COM- | GLASS | KBM5103 | UNSAT- | BENZYL | NPG | — | SPIN | FILM |
| PARATIVE | SUB- | | URATED | METHACRYLATE | | | COATING | (540 nm ± 50 nm) |
| EXAMPLE 4 | STRATE | | POLY- | | | | | |
| | | | ESTER | | | | | |
| | | | RESIN | | | | | |

KBM5103: SHIN-ETSU CHEMICAL CO., LTD. γ-acryloyloxypropyltimethoxysilane
NPG: SHIN-NAKAMURA CHEMICAL CO., LTD. neopentyl glycol diacrylate (NK ESTER A-NPG)
EX-212L: NAGASE CHEMTEX CORPORATION 1,6-hexanediol diglycidyl ether

The polymerizable resin composition was applied to the adhesion promoting layer 7 by a spin coating method.

In the step, the polymerizable resin composition applied to the adhesion promoting layer 7 on the substrate had a volume of 500 μL. In the spin coating method, the substrate 6 to which the polymerizable resin composition was applied was rotated until the rotation speed increased from 0 rpm to 5000 rpm in the first 10 sec, and then the substrate 6 was further rotated for 90 sec at the rotation speed of 5000 rpm, thereby to form a resin layer 8 on the adhesion promoting layer 7.

Then, the thickness of the resin film on the adhesion promoting layer was measured by an ellipsometer (EMS-7500: ULVAC INC.), showing the film thickness of 60 nm and the variety of ±0.5 nm or less. According to the step for applying the polymerizable resin composition using the spin coating method, the formation of the resin film 8 with a uniform thickness on the adhesion promoting layer 7 was determined. Note the thickness of the polymerizable resin composition (or resin film 8) was measured at the total of 12 points in the four directions crossing at right angles at 15 mm, 22 mm and 30 mm away from the periphery of the center hole of the substrate 6, to the outer periphery thereof.

Further, besides the sample for measuring the film thicknesses as mentioned above, in the same method as in FIG. 2B, was formed a resin film 8 on a substrate 6 through an adhesion promoting layer 7. Then, as shown in FIG. 2C, the prepared mold 5 was imprinted on the resin film 8 with a pressure of 0.45 kN for 30 sec, and then ultraviolet light of a wavelength of 365 nm was irradiated under the condition of 4.2 J/cm² so as to harden the resin film 8.

In the present example, as shown in FIG. 2D, the mold 5 was released from the hardened resin film 8, producing a microfine structure 10 having the resin film 8 onto which the convex concave patter of the mold 5 was transferred.

Then, the state of the transferred convex concave pattern on the resin film 8 (or microstructures 4) was observed by an optical surface analyzer (CANDELA CS10: KLA-TENCOR CORPORATION), demonstrating that the convex concave pattern was uniformly and indefectibly transferred.

Next, a part of the sample was released to measure a thickness of the base layer 9 (see FIG. 2D) of the convex concave pattern by an atomic force microscope (AFM). Accordingly, the base layer had a thickness of 10 nm with variety of ±2 nm or less. The production method of the microfine structure 10 demonstrated that an extremely thin and uniform thickness base layer 9 was formed.

Next, a method for producing a microfine structure 10′ prepared by etching a substrate 6 using a resin film 8 as a mask having the convex concave pattern will be explained referring to FIGS. 3A to 3D as mentioned hereinbefore.

In the present embodiment, as shown in FIG. 3A, was prepared a substrate 6 having a hardened resin film 8 with a transferred convex concave pattern. The convex concave pattern was transferred to the resin film 8 by the production method of the microfine structure (see FIGS. 2A to 2D). Note the reference 7 in FIG. 3A represents an adhesion promoting layer. Then, the resin layer 8 of the microfine structure 10 was etched by an oxygen plasma method.

As shown in FIG. 3B, an etching method using oxygen plasma was conducted until a surface of the substrate 6 was exposed. Then, an etching method using fluorine based gas plasma was conducted instead of the etching method using oxygen plasma.

Accordingly, as shown in FIG. 3D, the exposed substrate 6 was further etched using the resin layer 8 as a mask.

Then, the remaining resin film 8 and adhesion promoting layer 7 on the substrate 6 were removed by the oxygen plasma treatment. This process allowed a microfine structure 10′ having microstructures 4 corresponding to the convex concave pattern of the resin film 8 (see FIG. 3A) to be obtained.

Observation of the surface state of the microfine structure 10′ by an optical surface analyzer (CANDELA CS10: KLA-TENCOR CORPORATION) demonstrated that the convex concave pattern was uniformly and indefectibly formed.

### Example 2

A microfine structure 10 (see FIG. 2D) was formed in the same way as in Example 1 except that a silicon wafer (diameter=4 inch (10.2 cm)) used as a substrate 6 instead of the substrate 6 made of glass, and a master mold 3 made of silica instead of the prepared mold 5 (or resin mold 5) were utilized. Then, a microfine structure 10′ (see FIG. 3D) was produced using the above mentioned microfine structure 10.

Note the resin film 8 prepared by applying the polymerizable resin composition to the adhesion promoting layer 7 by a spin coating method had a thickness of 60 nm and variety of ±5 nm or less.

Further, the base layer 9 of the convex concave pattern formed on the resin film 8 (see FIG. 2D) had a thickness of 10 nm and variety of ±2 nm or less.

Then, observation of the surface state of the microfine structure 10′ by an optical surface analyzer (CANDELA CS10: KLA-TENCOR CORPORATION) demonstrated that the convex concave pattern was uniformly and indefectibly formed.

### Example 3

A microfine structure 10 (see FIG. 2D) was formed in the same way as in Example 1 except that an epoxyacrylate resin (number molecular weight (Mn)=780, BPE-10: SHIN-NAKAMURA CHEMICAL CO., LTD.) in one part by weight, benzyl methacrylate (molecular weight=176, FA-BZM: HITACHI CHEMICAL CO., LTD.) in one part by weight and neopentyl glycol diacrylate (molecular weight=212, SHIN-NAKAMURA CHEMICAL CO., LTD.) in one part by weight as monomer components; vinyl acrylate (molecular weight=112, ABCR LTD.) as a reactive dilution component in 30 parts by weight; and a photoreaction initiator (I-369: CIBA SPECIALITY CHEMICALS INC.) in 0.3 parts by weight were utilized, instead of the polymerizable resin composition. Then, a microfine structure 10′ (see FIG. 3D) was produced using the above mentioned microfine structure 10.

Note the resin film 8 prepared by applying the polymerizable resin composition to the adhesion promoting layer 7 by a spin coating method had a thickness of 60 nm and variety of ±5 nm or less.

Further, the base layer 9 of the convex concave pattern formed on the resin film 8 (see FIG. 2D) had a thickness of 10 nm and variety of ±2 nm or less.

Then, observation of the surface state of the microfine structure 10′ by an optical surface analyzer (CANDELA CS10: KLA-TENCOR CORPORATION) demonstrated that the convex concave pattern was uniformly and indefectibly formed.

### Example 4

A microfine structure 10 (see FIG. 2D) was formed in the same way as in Example 3 except that a silicon wafer (diameter=4 inch (10.2 cm) and a thickness of 525 μm) used as a substrate 6 instead of the substrate 6 made of glass, and a master mold 3 made of silica instead of the prepared mold 5 (or resin mold 5) were utilized. Then, a microfine structure 10′ (see FIG. 3D) was produced using the above mentioned microfine structure 10.

Note the resin film 8 prepared by applying the polymerizable resin composition to the adhesion promoting layer 7 by a spin coating method had a thickness of 60 nm and variety of +5 nm or less.

Further, the base layer 9 of the convex concave pattern formed on the resin film 8 (see FIG. 2D) had a thickness of 10 nm and variety of ±2 nm or less.

Then, observation of the surface state of the microfine structure 10′ by an optical surface analyzer (CANDELA CS10: KLA-TENCOR CORPORATION) demonstrated that the convex concave pattern was uniformly and indefectibly formed.

### Example 5

A microfine structure 10 (see FIG. 2D) was formed in the same way as in Example 1 except that a bisphenol AD type epoxy resin (number molecular weight (Mn)=350, EPDX-MX R1710: PRINTEC INC.) in one part by weight, phenyl glycidyl ether (molecular weight=150, EX-141: NAGASE CHEMTEX CORPORATION) in one part by weight and 1,6-hexanediol diglycidyl ether (molecular weight (Mn)=230, EX-212L: NAGASE CHEMTEX CORPORATION) in one part by weight as monomer components; aryl glycidyl ether (molecular weight=115, DENACOL EX-111: NAGASE CHEMTEX CORPORATION) as a reactive dilution component in 50 parts by weight; and ADECA OPTOMER (SP-172: ADECA CO.) in 0.3 parts by weight as a photoreaction initiator were utilized, instead of the polymerizable resin composition. Then, a microfine structure 10′ (see FIG. 3D) was produced using the above mentioned microfine structure 10.

Note the resin film 8 prepared by applying the polymerizable resin composition to the adhesion promoting layer 7 by a spin coating method had a thickness of 60 nm and variety of ±5 nm or less.

Further, the base layer 9 of the convex concave pattern formed on the resin film 8 (see FIG. 2D) had a thickness of 10 nm and variety of ±2 nm or less.

Then, observation of the surface state of the microfine structure 10′ by an optical surface analyzer (CANDELA CS10: KLA-TENCOR corporation) demonstrated that the convex concave pattern was uniformly and indefectibly formed.

### Example 6

A microfine structure 10 (see FIG. 2D) was formed in the same way as in Example 5 except that a silicon wafer (diameter=4 inch (10.2 cm) and a thickness of 525 μm) used as a substrate 6 instead of the substrate 6 made of glass, and a master mold 3 made of silica instead of the prepared mold 5 (or resin mold 5) were utilized. Then, a microfine structure 10′ (see FIG. 3D) was produced using the above mentioned microfine structure 10.

Note the resin film 8 prepared by applying the polymerizable resin composition to the adhesion promoting layer 7 by a spin coating method had a thickness of 60 nm and variety of ±5 nm or less.

Further, the base layer 9 of the convex concave pattern formed on the resin film 8 (see FIG. 2D) had a thickness of 10 nm and variety of ±2 nm or less.

Then, observation of the surface state of the microfine structure 10′ by an optical surface analyzer (CANDELA CS10: KLA-TENCOR CORPORATION) demonstrated that the convex concave pattern was uniformly and indefectibly formed.

### Comparative Example 1

The microfine structure 10 (see FIG. 2D) was formed in the same way as in Example 1 except that the polymerizable resin composition was applied to the adhesion promoting layer 7 so as to distribute it as droplets by an inkjet method instead of a spin coating method.

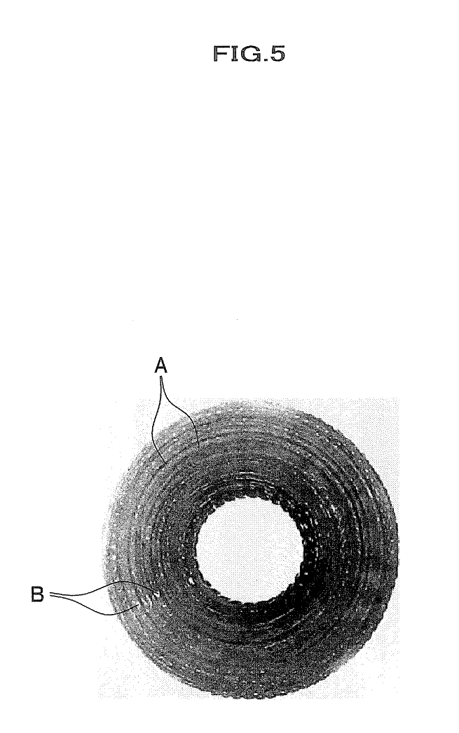

Note the base layer 9 (see FIG. 2D) of the convex concave pattern formed on the resin film 8 had a thickness of 10 nm. Observation of the surface state thereof by an optical surface analyzer (CANDELA CS10: KLA-TENCOR CORPORATION) demonstrated the uneven thicknesses and the defects in which no polymerizable resin composition was filled. FIG. 5 showed a photograph indicating a surface state of the microfine structure produced in Comparative Example 1 when the surface state thereof was observed by an optical surface analyzer.

As shown in FIG. 5, the uneven thicknesses of the resin film 8 appeared on the surface of the microfine structure formed in Comparative Example 1 as concentric circular shading stripes A. Further, the defects in which the polymerizable resin composition was not filled appeared as white blurs B in FIG. 5.

### Comparative Example 2

Prepared was a polymerizable resin composition containing no high molecular weight component (or styrene type unsaturated polyester resin) in the polymerizable resin composition used in Example 1. When a resin film 8 was tried to be formed on an adhesion promoting layer 7 similar to Example 1 using the prepared polymerizable resin composition (see FIG. 2B), the applied polymerizable resin composition was shrunken, thereby to be incapable of forming a spread resin film 8 as a film of the applied polymerizable resin composition on a substrate.

### Comparative Example 3

A resin film 8 was formed by applying a polymerizable resin composition to a substrate 6 in the same way as in Example 1 except that no adhesion promoting layer 7 was formed on the substrate 6. The resin film 8 had a thickness of 60 mm and variety was +5 nm or less.

However, when a mold 5 (see FIG. 2C) was released from the hardened resin film 8, the resin film 8 was also released from a substrate 6, resulting in no formation of a microfine structure 10 (see FIG. 2D).

### Comparative Example 4

As the polymerizable resin composition used in Example 1, was prepared a polymerizable resin composition containing no reactive dilution component (or vinyl methacrylate). A resin film 8 was formed on an adhesion promoting layer 7 in the same way as in Example 1 using the prepared polymerizable resin composition. Herein, the resin layer 8 had a thickness of 540 nm and the variety was ±50 nm or less.

The analysis demonstrated that such a polymerizable resin composition was incapable of forming a thickness of the resin layer 8 with 100 nm or less, and made the resin film 8 vary widely in the thickness.

### DESCRIPTION OF REFERENCE NUMERALS

1 Mold base material
2 Buffer layer
3 Master mold
4 Microstructures
4a Pattern layer
4b Linear protrusion
5 Mold
6 Substrate
6a Center hole
7 Adhesion promoting layer
8 Resin film
9 Base layer
10 Microfine structure
10′ Microfine structure
UV Ultraviolet light

1. A method for producing a microfine structure comprising:
an adhesion promoting layer forming step of forming an adhesion promoting layer on a substrate;
a resin film forming step of applying a liquid polymerizable resin composition containing a high molecular weight component, a low molecular weight component, and a reactive dilution component onto the adhesion promoting layer to form a resin film;
a mold imprint step of imprinting a mold with an extremely fine convex concave pattern on the resin film thereby to transfer the convex concave pattern on the resin film;
a hardening step of polymerizing the polymerizable resin composition with the mold kept imprinted onto the resin film thereby to harden the resin film; and
a release step of releasing the mold from the hardened resin film, wherein
the adhesion promoting layer components, the high molecular weight component, the low molecular weight component and the reactive dilution component respectively have cross-linking reactive functional groups which react with each other.

2. The method for producing a microfine structure as described in claim 1, wherein a number average molecular weight of the high molecular weight component is 300 or more and a number average molecular weight of the low molecular weight component is less than 300.

3. The method for producing a microfine structure as described in claim 1, wherein the low molecular weight component is a monomer.

4. The method for producing a microfine structure as described in claim 1, wherein an application method of the polymerizable resin composition in the resin film forming step is a spin coating method.

5. The method for producing a microfine structure as described in claim 1, wherein the functional groups undergo a cross-linking reaction each other by irradiation of ultraviolet light.

6. The method for producing a microfine structure as described in claim 1, wherein the functional group is a (meth)acrylate group or a vinyl group.

7. The method for producing a microfine structure as described in claim 1, wherein the functional group is an epoxy group or an oxetanyl group.

8. The method for producing a microfine structure as described in claim 1, wherein the adhesion promoting layer includes silicon.

9. The method for producing a microfine structure as described in claim 1, wherein a thickness of the resin film is less than 100 nm.

10. The method for producing a microfine structure as described in claim 1, wherein the substrate is in a disk shape having a concentric circular hole at a center of the substrate.

11. A method for producing a microfine structure comprising
an adhesion promoting layer forming step of forming an adhesion promoting layer on a substrate;
a resin film forming step of forming a resin film by applying a liquid polymerizable resin composition containing a high molecular weight component, a low molecular weight component, and a reactive dilution component onto the adhesion promoting layer;
a mold imprint step of imprinting a mold with an extremely fine convex concave pattern onto the resin film thereby to transfer the convex concave pattern on the resin film;
a hardening step of polymerizing the polymerizable resin composition with keeping on imprinting the mold onto the resin film thereby to harden the resin film;
a release step of releasing the mold from the hardened resin film; and
an etching step of forming microstructures corresponding to the convex concave pattern by etching the substrate using the hardened resin film with the transferred convex concave pattern as a mask, wherein
the adhesion promoting layer components, the high molecular weight component, the low molecular weight component and the reactive dilution component respectively have cross-linking reactive functional groups which react each other.

12. The method for producing a microfine structure as described in claim 11, wherein a number average molecular weight of the high molecular weight component is 300 or more, and a number average molecular weight of the low molecular weight component is less than 300.

13. The method for producing a microfine structure as described in claim 11, wherein the low molecular weight component is a monomer.

14. The method for producing a microfine structure as described in claim 11, wherein an application method of the polymerizable resin composition in the resin film forming step is a spin coating method.

15. The method for producing a microfine structure as described in claim 11, wherein the functional groups undergo a cross-linking reaction each other by irradiation of ultraviolet light.

16. The method for producing a microfine structure as described in claim 11, wherein the functional group is a (meth)acrylate group or a vinyl group.

17. The method for producing a microfine structure as described in claim 11, wherein the functional group is an epoxy group or an oxetanyl group.

18. The method for producing a microfine structure as described in claim 11, wherein the adhesion promoting layer includes silicon.

19. A microfine structure comprising a hardened resin film formed on a substrate through an adhesion promoting layer by imprinting a mold with an extremely fine convex concave pattern onto the resin film to transfer the convex concave pattern on the resin film, wherein
the resin film is formed by applying a polymerizable resin composition onto the substrate;
the polymerizable resin composition contains a high molecular weight component, a low molecular weight component and a reactive dilution component; and
the adhesion promoting layer components, the high molecular weight component, the low molecular weight component and the reactive dilution component respectively have cross-linking reactive functional groups which react with each other.

20. (canceled)
